(19) United States
(12) Patent Application Publication
(10) Pub. No.: US 2024/0344395 A1
(43) Pub. Date: Oct. 17, 2024

(54) MOBILE ESCALATING STEP LADDER SYSTEM WITH REMOTE CONTROL OPERATIONS

(71) Applicants: Gwendolyn Jenkins-Allen, Houston, TX (US); Robert L. Allen, Houston, TX (US)

(72) Inventors: Gwendolyn Jenkins-Allen, Houston, TX (US); Robert L. Allen, Houston, TX (US)

(21) Appl. No.: 18/636,451

(22) Filed: Apr. 16, 2024

Related U.S. Application Data
(63) Continuation-in-part of application No. 17/727,069, filed on Apr. 22, 2022.

(51) Int. Cl. E06C 7/12; E06C 1/16

(52) U.S. Cl. CPC E06C 7/12; E06C 1/16

(57) ABSTRACT

An automated system for raising and lowering a person to various desired levels and enables the person to more comfortably and safely perform activities and tasks that require them to be at an elevated position relative to floor or ground surface. This system can comprise a lift platform attached to a series of vertical rails. The present invention has the capability to enable a user to remotely control vertical movements of the standing platform and the horizontal movement of this invention. This invention can enable a user to remotely control vertical movements of the standing platform and the horizontal movement of this invention. A remote control device facilitates these control movements. This invention can also move laterally across a horizontal surface and can detect obstruction during these movements. As an obstruction is detected, this device has the capability to stop movement to ensure safety of a user.

### CROSS-REFERENCE TO RELATED APPLICATION

This application is a Continuation-in-Part patent application and relates to and claims priority from patent application Ser. No. 17/727,069, filed on Apr. 22, 2022. The contents of which are incorporated herein by reference.

### FIELD

This invention relates to a lifting device having a platform that automatically moves vertically as a person desires and automatically moves across a horizontal surface as directed by a user. More specifically, this invention relates to a step ladder in which a user can remotely control the vertical lifting and lowering of a standing platform and remotely control movement of the ladder device across a horizontal surface. More particular, this invention relates to a step ladder that a user can remotely raise and lower a person standing on the ladder platform without the person needing to take a step.

### BACKGROUND

Many home tasks require a person to elevate to perform the task. Tasks such as hanging a picture on the wall, retrieving an item from the top of a shelf, or changing a light bulb can require the use of a step ladder or step stool. In these cases, a person only needs to elevate a short distance (usually one to three feet) to accomplish the task. Although the elevation height in many instances is minimal, there are still risks involved whenever a person elevates (above the floor) to perform the activity. Depending on the type of step or rung on the stool or ladder, while taking a step, a person could miss the step or a foot could slip, causing the person to lose their balance and fall. Besides, while standing on the step ladder, some activities such as reaching or leaning may cause a person weight to shift which can result in a loss of their balance. Also, as a person ages, their ability to maintain their balance while stepping up or down the ladder can be questionable. As a result, some senior persons are reluctant or at best uncomfortable using stools and step ladders to elevate when needed for a task or job. Climbing these ladders or stools also requires the physical act of taking steps which some people may struggle to do.

These actions require the exertion of physical energy to take climbing steps and, as mentioned, risk losing one's balance. Many people have some physical limitation that makes repeatedly stepping up and down a ladder very challenging and, in some instances, dangerous. Traditional ladders and stools also have steps at fixed height distances. Depending on the application, these fixed distances may not be the desired or needed height for a task. As a result, the person may need to stretch to reach the desired position. As mentioned, these acts could bring about balance issues.

There have been past efforts to address this issue. U.S. Pat. No. 5,145,031 to Sprunger describes an electric ladder. This ladder is adjustable and comprises a pair of side supports, a device for retaining the supports in a spaced relationship, a rung, a device for slidably mounting the rungs in the supports, and a device for moving the rung along with the supports for adjusting the position of the rung.

U.S. Pat. No. 8,011,473 to Gregersen describes a motorized stepladder. This stepladder comprises a front frame and a rear frame, each formed of a pair of spaced side rails. A motor-driven step is slidably mounted on the front frame side rails. A remote unit controls the motor allowing a worker to automatically raise and lower the step when accessing an elevated area.

The physical construction of the traditional step ladders and physical limitations and concerns of some users can make activities requiring the use of a step ladder or stool a challenge and concern for some people. In addition, having to physically move and position the ladder can be another struggle for persons who may have some physical challenge. There remains a need for an automated step ladder that can be easily moved and positioned and which eliminates the need for a person to take steps or stand and balance on thin, narrow, and round ladder rungs when climbing or working without concern for slipping or falling off the ladder or stool.

### SUMMARY

This invention provides an automated escalating step ladder. This device has a moveable standing platform on which a person will stand. This moveable platform attaches to support legs that form the convention structural frame of the device. This invention also contains mechanical or electrical means to automatically raise and lower the standing platform along the device support legs to heights desired by the user. A power system supplies power to move, raise and lower the platform and person standing on the platform. The present invention has the capability to enable a user to remotely control vertical movements of the standing platform and the horizontal movement of this invention. This ability to automatically move the escalating step ladder device of this invention eases the burden of moving or working on the ladder. A remote control device facilitates these control movements. The present invention can also have a safety strap to secure a person while standing on the platform to maintain balance. The support legs can have designs of various configurations. The standing platform can have multiple designs including a fold out section to provide more platform surface for the person standing on the device.

### DESCRIPTION OF THE DRAWINGS

FIG. 1 is an illustration of an escalating step ladder of the present invention.

FIG. 2 is an alternate illustration of an escalating step ladder of the present invention.

FIG. 3 illustrates the support bar on top that can be pulled up if needed to activate the ladder manually.

FIG. 4 is an illustration of the charging pad and collapsing roller/wheels.

FIG. 5 is an illustration of the collapsing step feature of the standing platform of the present invention.

FIG. 5a is an illustration of the expandable collapsing step feature of the standing platform of the present invention.

FIG. 6a is an image of an attachable tray in an alternate embodiment of the present invention.

FIG. 6b is an illustration of the attachable tray engaged with the support bar at the top of the escalating step ladder of the present invention.

FIG. 7 is an illustration of an attachable and optional support brace of the present invention.

FIG. 8 illustrates an alternate embodiment of the present invention showing the support brace attached to the step ladder.

FIG. 9 illustrates an outlet in support of the present invention to facilitate the supply of power to the means, which automatically moves the standing platform.

FIG. 10a shows a configuration of an automated remote control system for the escalating step ladder of the present invention with joint wheel control.

FIG. 10b shows a configuration of an automated remote control system for the escalating step ladder of the present invention with individual wheel control.

FIG. 11 shows a remote control device for implementation of the automated control system of the present invention.

FIG. 12 shows a system of wheel sensors for obstruction detection.

FIG. 13 shows a configuration of gear system for wheel control and ladder movement.

FIG. 14 shows a flow diagram of automated escalated ladder control process.

FIG. 15 shows a detailed flow diagram of the command sequences of the automated escalated ladder control process of the present invention.

### DETAILED DESCRIPTION OF THE INVENTION

The present invention provides a step ladder with a step platform that automatically moves up and down along the support legs to a height desired by the user. With this invention, once the user steps onto the platform, the user does not need to take any additional steps to move vertically on the ladder. As a result, the user does not have concerns about falling or losing his or her balance while trying to step or stand on the ladder.

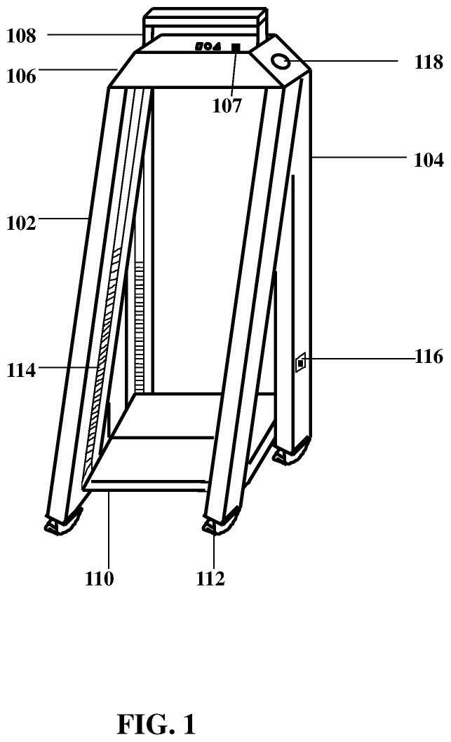

FIG. 1 illustrates the preferred embodiment of the present escalating step ladder invention. This ladder invention comprises two sets of vertical support legs 102 and 104. The tops of these support legs connect to a top base 106. The top base can contain an optional attachable tray 108. This tray can have multiple applications, such as serving as a place to lay tool items when a person is working. The user can raise this bar up and lower it down. The collapsible standing platform 110 attaches to the sets of support legs 102 and 104 at the support legs' lower end. The bottom end of the support legs can contain rollers or wheels 112 to facilitate the ladder movement. These wheels can have the capability to lock into place to address safety concerns when the user desires to keep the ladder in a stationary position. In an alternate embodiment of this invention, the rollers collapse into the support legs. This invention can have a mechanical system of grooves or threads 114 positioned in the inner side of the support legs to move the standing platform in vertical directions. The grooves or threads attach to the support platform and serve as a track for the standing platform's movement. A gear system attached to the grooves or threads and connected to an electric motor can initiate the force to raise and lower the standing platform as desired by the user. An electrical plug 116 on one of the support legs can connect the motor with an external electrical power source to power the motor and move the standing platform. Although not shown, an electric motor can be housed at the base of one of the legs or beneath the standing platform. Mechanical means such as rods can connect the motor to the gear system to provide the mechanical force required to raise and lower the standing platform. A manual override device 118 can be a control button or lever. This device allows the user to manually move the standing platform in the event the electrical controls fail. The controller device 107 on top base 106 connects to the electric motor or another power source to enable the user to control the height of the standing base and the vertical movement of the standing base.

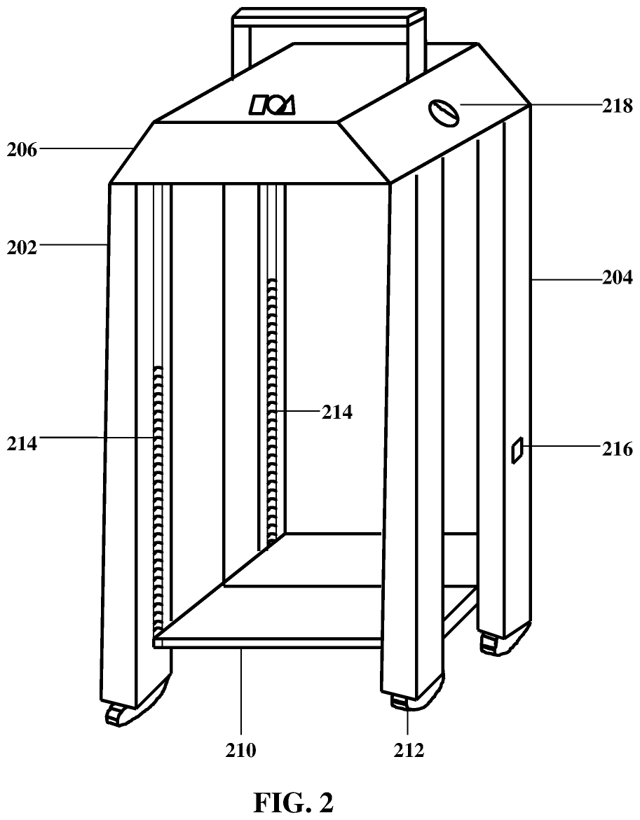

FIG. 2 is an alternate embodiment of the escalating step ladder of the present invention. In this embodiment, the sets of leg support 202 and 204 are all in a vertical position. This configuration differs from the support leg configuration of FIG. 1. In FIG. 1, at least one pair of support legs is in an angled position. Many conventional ladders extend outward into an “A” type configuration. The design in FIG. 2 is in part to simplify the means 214 to raise and lower the standing platform 210.

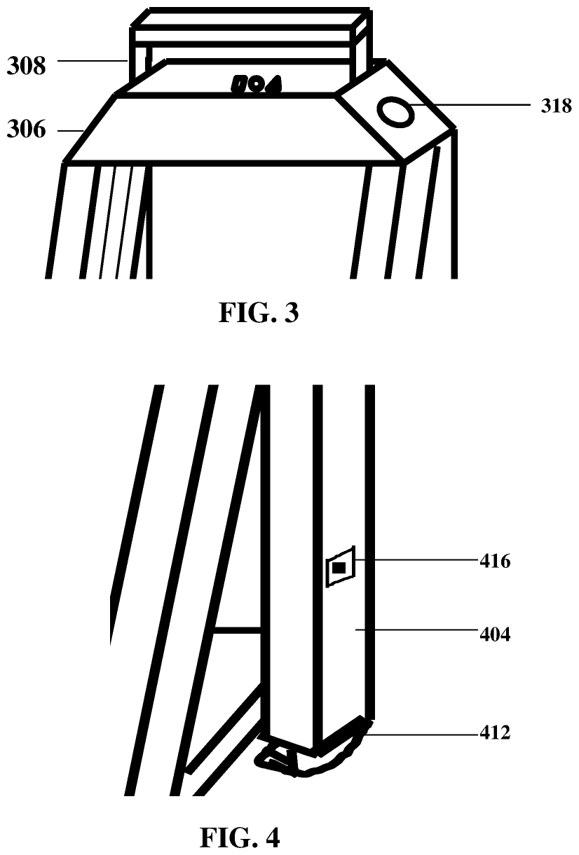

FIG. 3 shows the top base 306 and the attachable support tray bar 308 on top. A user can pull up this attachable tray bar if needed to activate the ladder manually. As mentioned, the ladder is designed to be automatically activated and controlled with the controller 318 positioned on the top base 306. However, this invention does have a manual control option if the automated control system fails to function correctly. With the manual control option, the user can disengage the motor and gear assembly that raises and lowers the standing platform. The user can physically adjust the device as desired. This ability would be extremely useful in cases when the automatic operational option malfunctions.

FIG. 4 is a close-up view of the charging pad 416 and collapsing roller/wheels 412. As mentioned, the charging pad 416 is incorporated into one of the support legs 404. The charging pad is the means through which power is supplied to raise and lower the standing platform automatically. As mentioned, the power source (electrical motor) can be positioned in or near the base of one of the support legs.

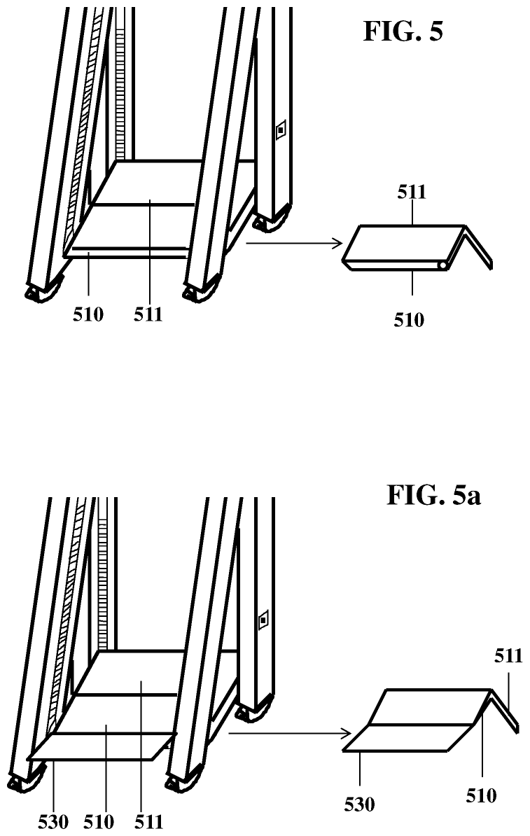

FIG. 5 shows the collapsing step feature of the standing platform 510 of the present invention. In this invention, the support legs and the standing platform can collapse down when the ladder is not in use for storage purposes. A fold 511 in the standing platform 510 provides the capability of the standing form to collapse. FIG. 5a shows an embodiment with the standing platform having three sections 511, 510 and 530. Section 530 attaches to section 510 and provides additional surface on which a person may stand. This section 530 can fold over section 510 and fit on top of section 510 during regular use, if a user does not desire the additional surface area on which to stand.

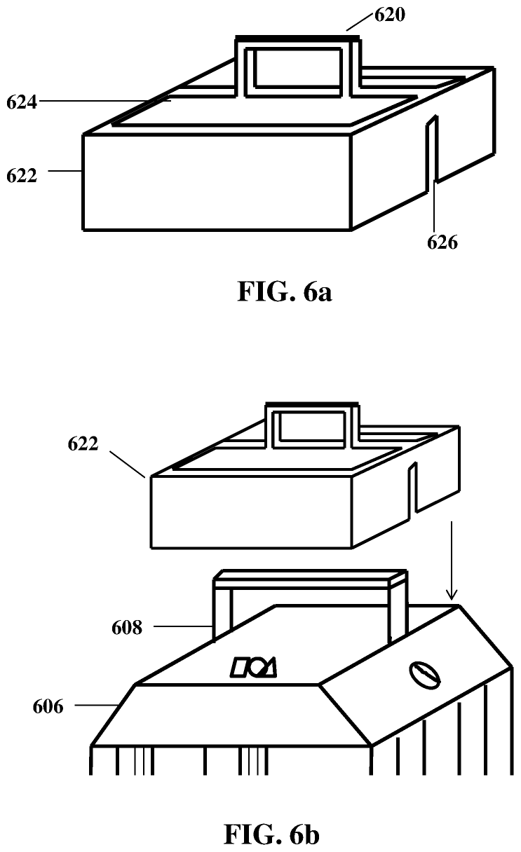

FIGS. 6a and 6b are images of an attachable tray in an alternate embodiment of the present invention. As shown, this tray attaches to the 622 to the tray 608, which is attached to the top base 606. This attachable tray has a handle 620, a top surface 624, and side grooves 626 To enable the tray to fit over the tray bar easily. This tray can serve as a place on which the user can set items once retrieved. In addition, for other applications such working on home improvement projects, the user can place or store useful tools on this tray.

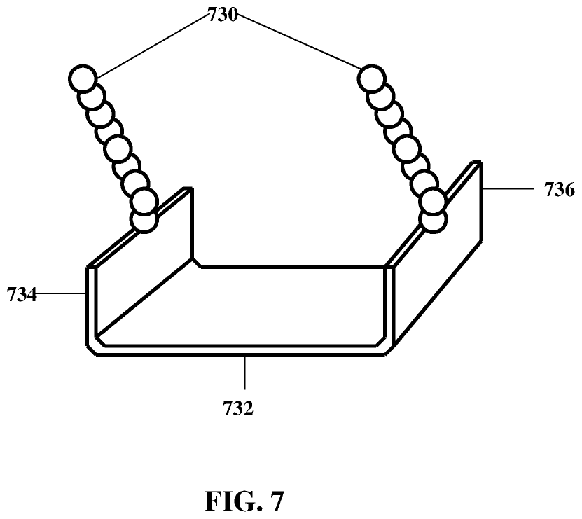

As mentioned, a primary concern with performing activities that require a person to elevated is maintaining one's balance while elevated. To further address that concern, FIG. 7 shows the optional attachable support brace of the present invention. This optional piece has a back support 732 and flexible attaching arms 730 to secure the back support to the ladder legs. This piece also has side support straps or chains 734 and 736 that extend outward from the back support. These side supports create a more confined space and further stability in the back support. This support brace will provide additional support to a person on the ladder and prevent them from falling backward off the ladder. This feature may be particularly beneficial to persons who have concerns about losing their balance and falling.

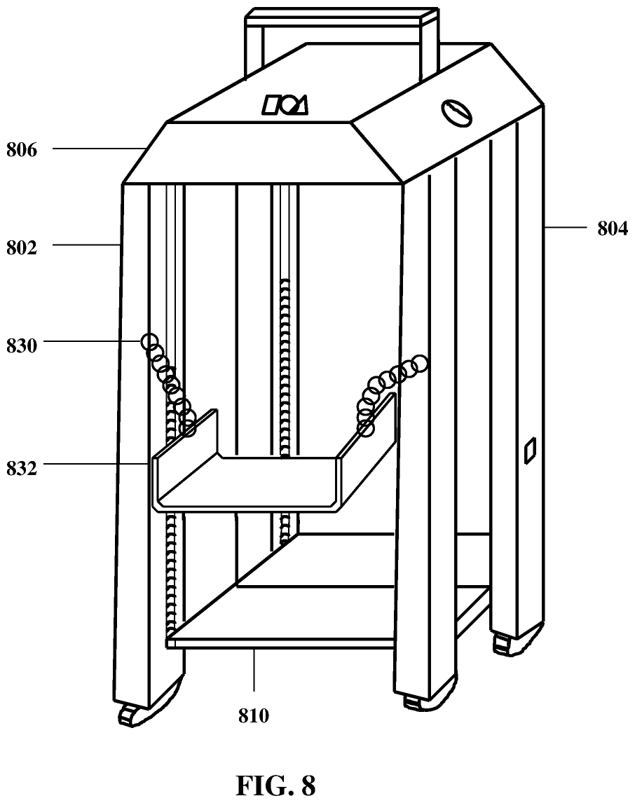

FIG. 8 illustrates an alternate embodiment of the present invention showing the support brace 832 attached to the step ladder through connecting arms 830. In full application, the ladder support legs 802 and 804 attach to the top base 806. As the person moves up the ladder on the standing platform 810, the attaching arms 830 can also enable the support brace to move with the person as they raise or lower the standing platform.

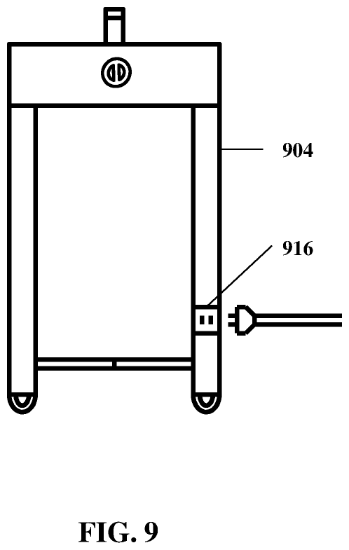

FIG. 9 illustrates an outlet supporting the present invention to facilitate the supply of power to the means, which automatically moves the standing platform. In the present invention, the power source can be a mobile source such as a battery. The power source can also be an external source, such as power from a wall outlet. As shown, the power outlet 916 and other connections can be positioned in one of the support legs 904. Through this outlet 916, one can power the electric motor or power means directly from the wall power source. However, one can also use outlet 916 to charge a battery power source.

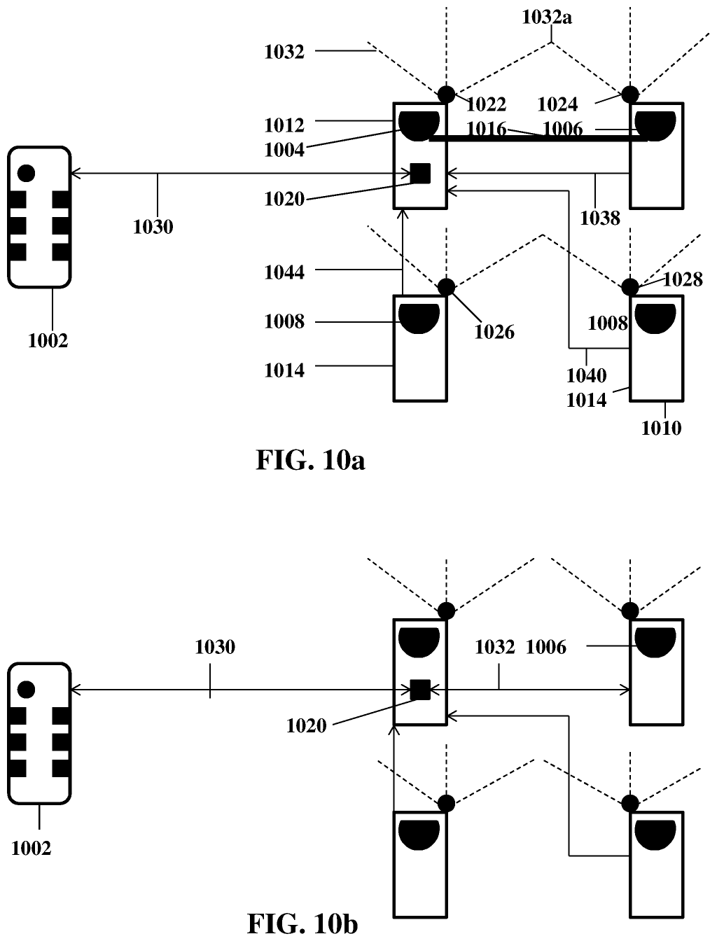

While the present invention has been illustrated by the description of embodiments thereof, and while the embodiments have been described in some detail, it is not the intention of the applicant to restrict or in any way limit the scope of the invention to such information. In an alternate embodiment of the present invention, an automated control system can be implemented using a remote control device. In this system, the remote controller performs the same function as the attached controller device 107. FIGS. 10a and 10b show the configuration of the automated control system using a remote control device. As shown, two sets of support legs 1012 for the front of the ladder and legs 1010 and 1014 for the rear of the ladder attach to a system of wheels to facilitate ladder movement. Front wheels 1004 and 1006 attach to the pair of front ladder legs. Rear wheels 1008 attach to the pair of rear ladder legs 1014. Attached to each ladder leg is a sensor 1022, 1024, 1026 and 1028. These sensors monitor for obstructions on the horizontal surface when the ladder moves across the surface as directed by the user. These sensors send out signals 1032 and 1032a to sense for obstructions. As shown, the sensor signals will overlap to ensure coverage of the entire surface in the path of the ladder.

A master ladder leg controller 1020 located in one of the ladder legs provides the local control for the ladder movements. This controller coordinates the movements of the ladder legs and is in direct communication with the remote controller 1002 through communication link 1030. The master ladder leg controller is also in direct communication with sensors located on each ladder leg and specifically controls the wheel movements. The controller can also facilitate steering of the front wheels in a direction desired by the user. This controller can send out a signal to each ladder leg sensor to stop wheel movement of the wheel connected to that leg. Communication links are established between each ladder leg sensor and the master ladder leg controller. Communication links 1038, 1040 and 1044 establish communication with the leg controller 1020.

In FIG. 10a, the front wheels 1006 and 1012 are physically connected to steering rod 1016 to synchronize steering movements of the front wheels. The user has the capability to steer the front wheels and thereby steer the movement of the ladder. FIG. 10b is similar to FIG. 10a. However, in FIG. 10b, each front wheel has independent movement as opposed to being physically tied with a steering rod for movement synchronization. There is two-way communication between the master ladder controller 1020 and both front ladder leg wheels.

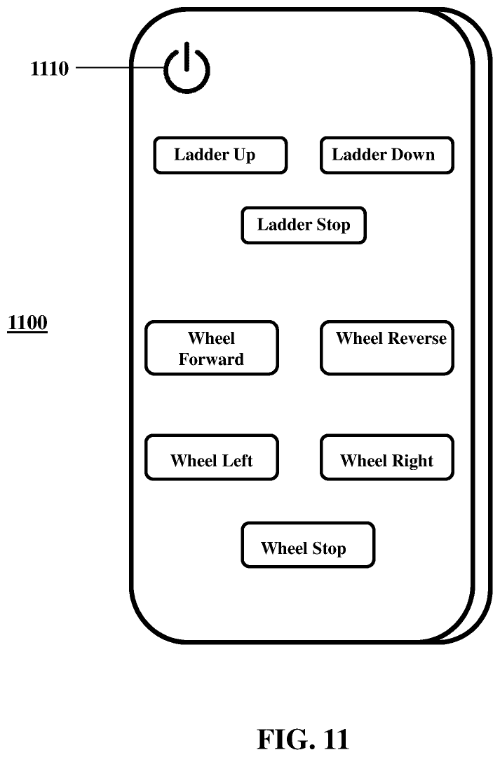

FIG. 11 shows a remote control device 1100 for implementation of the automated control system of the present invention. This device enables a user to control ladder platform movements and control the height of the platform and control lateral movements of the ladder. This remote has the power button 1110. This remote also has buttons for the various platform and wheel commands. For the platform commands, buttons shown include Ladder Up, Ladder Down and Ladder Stop buttons. The Ladder Up button enables the user to initiate platform movements in a vertical direction to enable lifting a person on the platform and raise that person's height as desired. The ladder stop button is optional and can stop the upward movement of the platform when desired. Also, when the desire is the lower the platform, the ladder down button can control lowering the platform. This remote controller can enable the user operate the ladder from a distance. This arrangement may be desirable when one person is on the platform and another person is operating the device. The movement of the platform in each direction can be in predetermined discrete lengths or the movement can be in a continuous movement with the user stopping the movement as desired.

This remote also has buttons to control the wheel movements. The Wheel Forward and Wheel Reverse buttons control lateral movements of the ladder to move from one location to a different location desired by the user. Similar to the platform movements, the user can stop the movements when desired using the Wheel Stop button. As the ladder moves in forward or reverse direction it may be desirable to alter the path traveled by the ladder. Therefore steering buttons Wheel Left and Wheel Right buttons enable to user to steer and alter the direction of the ladder movement. The steering movements can be discrete movements. For example, pressing the Wheel Left button once may cause the wheels to move 30 degrees in the left direction causing the ladder to turn 30 degrees to the left. Pressing the Wheel Left button can cause the ladder to move another 30 degrees to left. The discrete degree movement could vary. The degree movements could be in 10 degree segments for example. This remote controller has more capabilities than the platform controller 318. The platform controller only permits the user to raise or lower the platform. A user cannot use the platform controller to move or steer the ladder.

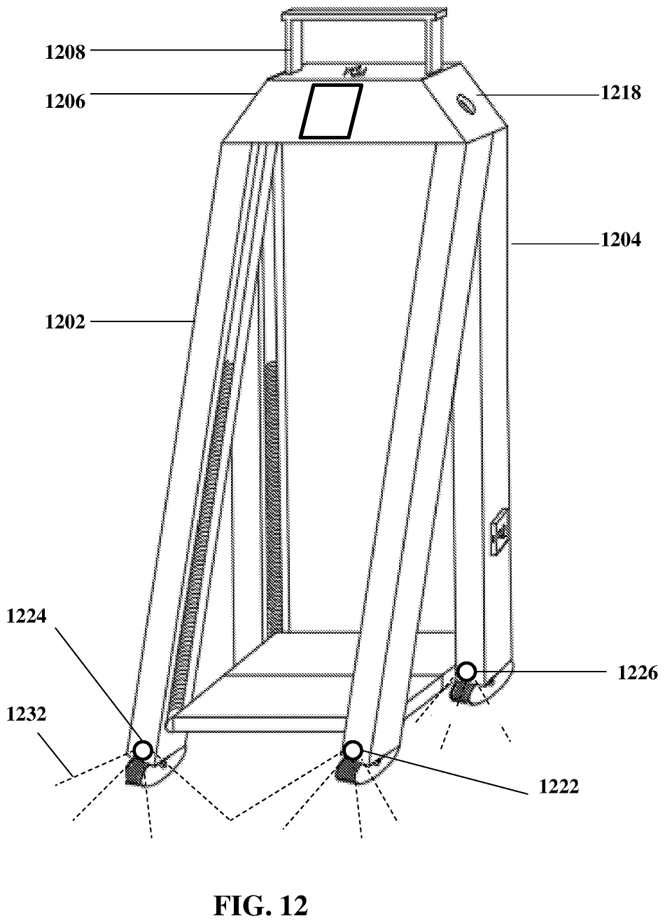

FIG. 12 shows a system of wheel sensors for obstruction detection. Shown are three of the four leg sensors 1222, 1224 and 1226. Each sensor submits signals 1232 to detect any obstacles that the ladder may encounter as it moves across the horizontal surface. These sensors are also active during the standing platform movements. The intent is to detect any object under the ladder at any time. If an obstruction is detected, a signal would go the master controller 1020 to stop the wheel motion.

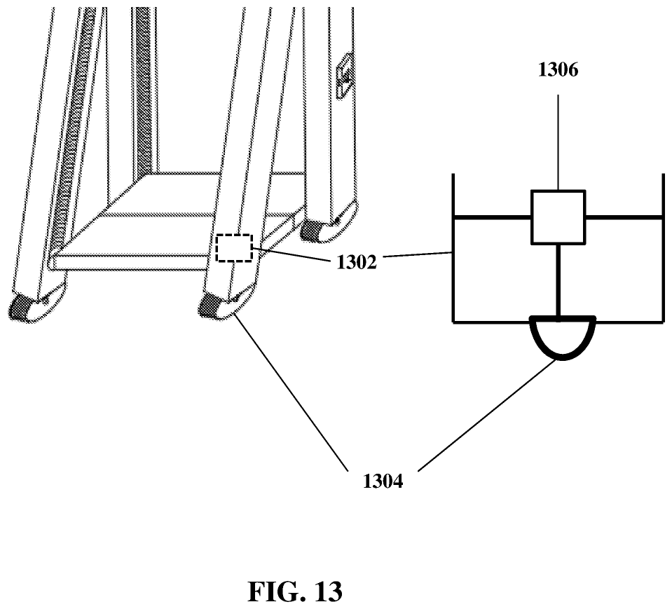

FIG. 13 shows a configuration of a gear system for wheel control and ladder movement. The wheel in each ladder leg is connected to a gear system 1302 positioned and attached to a wheel 1304. The gear system can include an electric motor and sensor 1306 connected to gears to control the gears and movement of the wheel. The sensor can detect commands from the leg controller 1020 which are implemented in the motor and wheel. In another configuration, only the front two wheels can have gear systems.

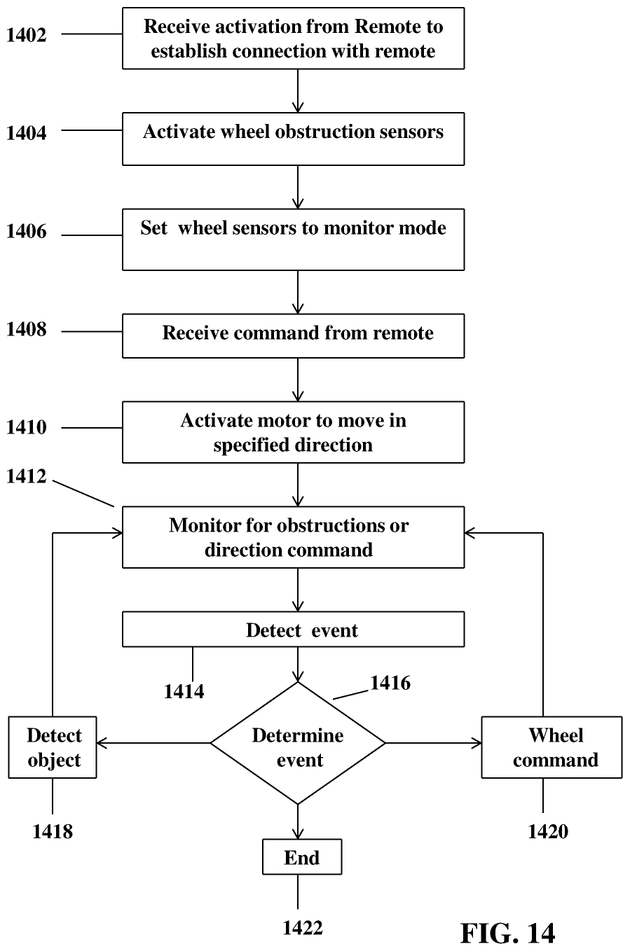

FIG. 14 shows a flow diagram of the steps in the automated escalated ladder control process. In step 1402, the user can activate the system using the remote control by turning on the remote control device. The leg controller 1020 can receive the signal and establish a virtual connection with the remote 1100. Step 1404 activates the wheel obstruction sensors. This activation comes from the leg controller 1020. Once the wheel sensors are activated, step 1406 sets the wheel sensors to a monitor mode. At this time, the sensors have the ability to detect if there is an obstacle in the path and direction of the ladder. Step 1408 is a command from the user through the remote device for the wheels to move in a direction. This command is detected and identified as a command for the gear system and not for obstruction detection. As a result of detecting the signal in step 1408, step 1410 activates the motor to move in a specific direction. When the ladder begins to move in response to the command in step 1410, the wheel sensors 1222, 1224, 1226 and 1228 begin to monitor for obstructions in step 1412. As the ladder moves, step 1412 also monitors for additional instructions for movement directions. While the ladder is moving, step 1414 detects an event. The event could be the detection of an obstacle in the path of the ladder or a command from the user to alter the direction of movement of the ladder. Once an event is detected in step 1414, step 1416 determines if the detected event is the detection of an object or the detection of a wheel command. If the detected event is a detected object, the method moves to step 1418. In this step, the wheels are stopped and then the process moves back to step 1412 which is the monitoring step. If in step 1416, the determination is that the event is a wheel command, the command is interpreted and the wheels are controlled to respond to the command. The process again returns to the monitoring step 1412. If in step 1416, the determination is that the user wants to stop the movement of the ladder, step 1422 stops the movement of the ladder.

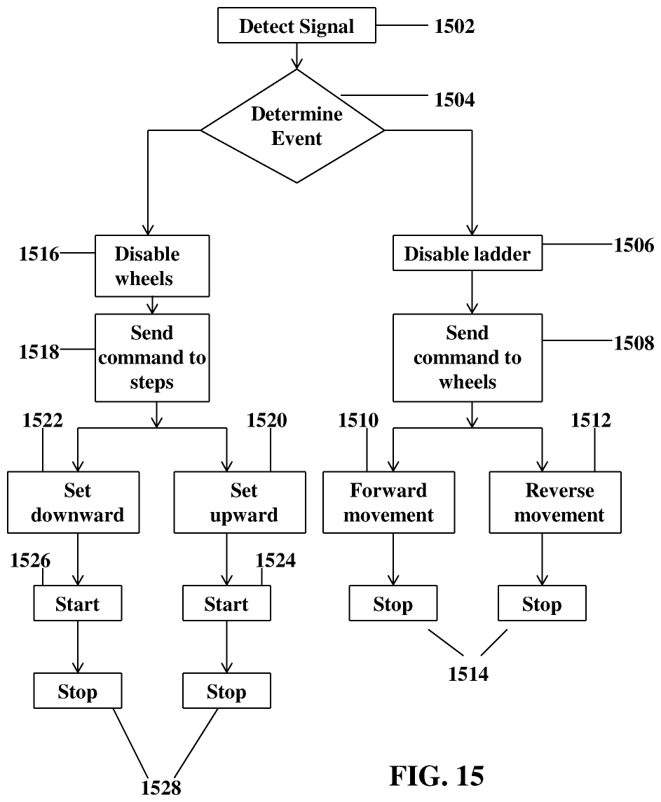

FIG. 15 shows a detailed flow diagram of the command sequences of the automated escalated ladder control process of the present invention. During this process, the user has already activated the system and established communication with the ladder controller 1020. Establishing communication between the user via the remote or platform controller and the user activates the wheel sensors obstruction sensors in anticipation of platform of ladder movement. Step 1502 detects an event at the ladder controller 1020. In step 1504, there is a determination of the event. If the determination is the event is related to the movement of the wheels, the process moves to step 1506 which disables or stops the ladder platform movement. The ladder and wheels will not move simultaneously. After the movement in the ladder has stopped, in step 1508 the ladder controller 1020 sends a command to the wheels to move in a forward direction in step 1510 or in a reverse direction in step 1512. These commands can also steer the wheels in left and right directions. Step 1514 moves the process to stop. The stop step will be perform by receiving a stop command from the remote control by the user or if an obstruction is detected by the sensors. Referring again to step 1504, if the determination is that the detected event is related to the ladder movement, the process moves the step 1516 which disables the wheel movement. Again, the wheels and ladder platform cannot move at the same time. Step 1518 sends a command to move the platform. If the platform movement is set upward in step 1520, step 1524 starts the platform movement in the upward direction. The user then stops the movement in step 1528. Referring back to step 1518, if the platform movement is set downward in step 1522, step 1526 starts the platform movement in the downward direction. The user then stops the movement in step 1528. These steps can ensure that movements of the ladder platform and the movements of the wheels and horizontal movement of the ladder will not simultaneously occur. This system provides safety of movement in this process and protects one positioned on the ladder platform.

Additional advantages and modifications will readily appear to those skilled in the art. The invention, in its broader aspects, is not limited to the specific details, representative apparatus and methods, and illustrative examples shown and described. Accordingly, departures may be made from such details without departing from the spirit or scope of the applicant's general inventive concept.

I claim:

1. An automated system for vertically elevating a user to a desired height level for performing activity comprising:
a ladder frame structure comprising at least three vertical leg structures, said legs being linear and having an upper end and a lower end and being connected to each other to sustain support when weight is placed on them;
standing platform connected and supported by said vertical leg structures, said standing platform being capable of moving vertically along said leg structures while supporting a user standing on said standing platform;
a power system connected to said standing platform for supplying mechanical power to raise and lower said standing platform while supporting a user standing on said standing platform; and
a control system to remotely control mobility of said ladder frame structure and said standing platform, said controller system comprising a ladder master controller, a plurality of obstruction detection sensors and wherein said control system enables a user to control vertical movements of said standing platform and horizontal movements of said frame.

2. The automated system for vertically elevating a user to a desired height level as described in claim 1 wherein said ladder frame structure further comprises at least four said vertical leg structures positioned to form a rectangular structure relative to each other and wherein each vertical leg of said ladder frame structure is connected to said foldable stand structure such that said standing platform can move vertically relative to the position of said vertical leg structures.

3. The automated system for vertically elevating a user to a desired height level as described in claims 2, wherein said power system further comprises a gear system connected to an electric motor, said gear system having a sensor and being in communication with said ladder controller, said gear system also being connected to each of said vertical leg structures and said standing platform, such that when the electric motor supplies power to the gear system, the gear system will cause said stand structure to vertically and transverse along said vertical leg structures enabling a user supported by said ladder frame structure to move in a vertical direction.

4. The automated system for vertically elevating a user to a desired height level as described in claim 3 further comprising transporting grooves in said vertical leg structures that engage with said gear system to facilitate vertical movement of the said stand structure.

5. The automated system for vertically elevating a user to a desired height level as described in claim 3 further comprising a back support element, said back support element having a smooth flat surface with two ends to engage a user's back and support straps attached to each end of said back support element, said support straps also attached to vertical leg structures of said ladder frame structure to support user while on said foldable stand structure.

6. The automated system for vertically elevating a user to a desired height level as described in claim 2 further comprising rollers attached to the lower end of each said vertical leg structures, said rollers being able to facilitate easier movement of said frame structure and said rollers being controlled by said ladder master controller and rollers being able to lock into place to maintain a stationary position of said frame structure.

7. The automated system for vertically elevating a user to a desired height level as described in claim 5 wherein said standing platform comprises two base folding sections and an extension section connected to one of the base folding sections and wherein said extension section can fold over onto the base folding section connected to it.

8. The automated system for vertically elevating a user to a desired height level as described in claim 2 further comprising a top base positioned on the top end of said vertical legs of said frame structure, said top base comprising four base elements, each base element having a top edge, bottom edge and two side edges, said four sides being connected to each other at the side edges, a base platform comprising a flat surface element connected to the top sides of the connected base elements, said base platform providing a location to set items during a user's activity.

9. The automated system for vertically elevating a user to a desired height level as described in claim 8 further comprising a tray element slidably attached and secured to said base platform, said tray element attached to said base platform through an opening in said base platform such that a user can extend said tray element upward from said and lock the tray in place and user can retract said tray through the opening in the base platform such that a tray element top will fill in the opening in said base platform when said try element is not in use.

10. The automated system for vertically elevating a user to a desired height level as described in claim 3 further comprising an electrical plug inlet to which said electric motor is connected to facilitate supplying electrical power to said electric motor.

11. The automated system for vertically elevating a user to a desired height level as described in claim 2 wherein said vertical leg structures of said frame structure further comprises an ‘A’ configuration.

12. The automated system for vertically elevating a user to a desired height level as described in claim 8 further comprises a controller device connected to said electric motor to enable a user to remotely control lifting and lowing functions of said foldable stand structure.

13. The automated system for vertically elevating a user to a desired height level as described in claim 12 further comprising a manual override to control lifting and lowing functions of said foldable stand structure.

14. An automated system for vertically elevating a user to a desired height level for performing activity comprising:
a frame structure comprising at least four vertical leg structures, said legs being linear and forming a frame structure in the form of an ‘A’ frame configuration and having an upper end and a lower end and being connected to each other to sustain support when weight is placed on them;
a foldable stand structure connected and supported by said vertical leg structures of said frame structure, said foldable stand structure being capable of moving vertically along said vertical leg structures while supporting a user standing on said stand structure, said foldable stand structure comprises two base folding sections and an extension section connected to one of the base folding sections and wherein said extension section can fold over onto the base folding section connected to it;
a back support element, said back support element having a smooth flat surface with two ends to engage a user's back and support straps attached to each end of said back support element, said support straps also attached to vertical leg structures of said frame structure to support user while on said foldable stand structure.
a power system connected to said stand structure for supplying mechanical power to raise and lower said stand structure while supporting a user on said stand structure, said power system comprising a gear system connected to an electric motor, said gear system also being connected to each of said vertical leg structures and said foldable stand structure, such that when the electric motor supplies power to the gear system, the gear system will cause said stand structure to vertically and transverse along said vertical leg structures enabling a user supported by said frame structure to move in a vertical direction; and
a controller device to enable a user standing on said stand structure to control speed and height of said stand structure

15. The automated system for vertically elevating a user to a desired height level as described in claim 14 further comprising a top base positioned on the top end of said vertical legs of said frame structure, said top base comprising four base elements, each base element having a top edge, bottom edge and two side edges, said four sides being connected to each other at the side edges, a base platform comprising a flat surface element connected to the top sides of the connected base elements, said base platform providing a location to set items during a user's activity.

16. A method for controlling mobility of a self-supporting ladder frame structure having a support platform for standing capable of vertical movement along the frame structure and having a power system having a motor and power source for supplying power to raise and lower the standing platform, said method comprising:
establishing communication between a ladder controller on the ladder frame structure and a remote control device operated by a user such that the user is capable of sending commands to the ladder controller to control ladder frame structure mobility and support platform movement;
activating wheel obstruction detection sensors to set wheel sensors to monitor mode;
receiving a command at the ladder controller from the remote control;
determining at the ladder controller an action to perform in response to the received command;
performing the determined action in response to the received command from the remote control;
monitoring for obstructions by the wheel obstruction detection sensors while performing the determined action; and
receiving a command to stop performing the determined action.

17. The method controlling mobility of a self-supporting ladder frame structure as described in claim 16 wherein said action determination in response to the received command further comprises determining whether the action is for the standing platform or ladder wheels.

18. The method controlling mobility of a self-supporting ladder frame structure as described in claim 16 wherein performing the determined action is moving the standing platform in a upward or downward direction.

19. The method controlling mobility of a self-supporting ladder frame structure as described in claim 16 wherein performing the determined action is rotating wheels under the self-supporting ladder frame structure and moving the self-supporting ladder frame structure.

20. The method of controlling mobility of a self-supporting ladder frame structure as described in claim 16 further comprising after said monitoring for obstructions:
detecting an obstruction;
sending a signal to the ladder controller; and
sending a stop command from the ladder controller.
